(19) United States
(12) Patent Application Publication
(10) Pub. No.: US 2019/0212350 A1
(43) Pub. Date: Jul. 11, 2019

(54) An Autonomous Sampling System

(71) Applicant: Project Management Limited, Dublin (IE)

(72) Inventor: David Wolton, County Wicklow (IE)

(21) Appl. No.: 16/333,765

(22) PCT Filed: Sep. 18, 2017
(86) PCT No.: PCT/EP2017/073477

§ 371 Date: Mar. 15, 2019

(30) Foreign Application Priority Data
Sep. 19, 2016 (IE) S2016/0228

(51) Int. Cl. G01N 35/00; G01N 35/04; G01N 35/10

(52) U.S. Cl. CPC G01N 35/0099; G01N 35/04; G01N 35/00732; G01N 2035/0475; G01N 2035/0441; G01N 2035/0434; G01N 35/1009

(57) ABSTRACT

The present invention is concerned with an autonomous sampling system for use in a pharmaceutical facility in order to effect the autonomous sampling of pharmaceutical substances being manufactured in the facility and/or for effecting the autonomous sampling or monitoring of environmental conditions within the facility.

### FIELD OF THE INVENTION

This invention relates to an autonomous sampling system for use in environments such as but not limited to, a pharmaceutical and biopharmaceutical manufacturing facilities, and further allowing such sampling or environmental monitoring to be carried cut at any time irrespective of the presence of a human operator, thereby allowing such facilities to effectively operate continuously twenty four hours a day.

### BACKGROUND OF THE INVENTION

Within various hi-tech industries, for example the pharmaceutical and biopharmaceutical industries, in view of the significant monetary value of substances being produced or processed, in addition to the stringent requirements for the physical/chemical characteristics of the substances to remain within very tight tolerances, it is an essential requirement that these substances are regularly analyzed in order to ensure that the above criteria are adhered to.

It is also often a requirement to monitor the environmental conditions within the facilities of the above mentioned industries, which can have extremely strict requirements regarding particulate levels, microbial levels, etc in the air, and these requirements will often vary significantly between different areas within the facility.

In addition, due to the complexity and therefore high cost of the equipment used in such pharmaceutical facilities, in order to ensure a reasonable return on investment it is generally a requirement that the facilities operate essentially twenty four hours a day. This does however lead to a requirement for significant staffing levels at such facilities, in particular to take regular product samples from the production line and to have said samples analyzed. For environmental monitoring it is often a requirement for an operator to travel around the facility and to perform various types of environmental monitoring tests, which will generally require the operator to be present during the entire test and to note any localised activities or events which occur during the testing and which could have an effect on the results of the test. All of these issues add to the staffing and cost base of such pharmaceutical facilities.

It is therefore an object of the present invention to address the above mentioned problems.

### SUMMARY OF THE INVENTION

According to a first aspect of the present invention there is provided an autonomous sampling system comprising a base adapted for autonomous locomotion about a pharmaceutical facility; and an actuator operable to interact with a sampling assembly.

Preferably, the autonomous sampling system comprises one or more ground contacting wheels adapted to facilitate locomotion of the base; and a wheel disinfecting assembly operable to effect disinfection of the one or more ground contacting wheels.

Preferably, the wheel disinfecting assembly comprises at least one nozzle arranged adjacent one or more of the wheels and operable to apply a disinfectant onto the one or more wheels.

Preferably, the wheel disinfecting assembly comprises a disinfectant reservoir in fluid communication with the at least one nozzle.

Preferably, the autonomous sampling system comprises control means operable to effect the position dependent actuation of the wheel disinfecting assembly.

Preferably, the autonomous sampling system comprises an actuator disinfecting assembly.

Preferably, the actuator disinfecting assembly comprises a receptacle for receipt of a portion of the actuator and a dispenser operable to dispense a disinfectant into or about the receptacle.

Preferably, the actuator disinfecting assembly comprises at least one nozzle operable to apply a disinfectant to the portion of the actuator located in the receptacle.

Preferably, the actuator disinfecting assembly comprises a disinfectant reservoir in fluid communication with the at least one nozzle.

Preferably, the autonomous sampling system comprises control means operable to effect the position dependent actuation of the actuator disinfecting assembly.

Preferably, the autonomous sampling system comprises a video monitoring system.

Preferably, the video monitoring system comprises one or more video cameras arranged to capture 360° video of the environment surrounding the system.

Preferably, the autonomous sampling system comprises a transmission system operable to effect the secure transmission of information between the system and a remote location.

Preferably, the autonomous sampling system comprises a storage compartment for receiving one or more sampling assemblies.

Preferably, the autonomous sampling system comprises a power supply arranged lo supply power for the locomotion of the base and to supply power for operation of the actuator.

Preferably, the autonomous sampling system comprises a gripper located at a free end of the actuator.

Preferably, the autonomous sampling system comprises a sampling assembly carried on the base and adapted to retain at least one sample of a substance.

Preferably, the sampling assembly comprises a discrete sample reservoir.

Preferably, the sampling assembly comprises a plurality of discrete sample reservoirs.

Preferably, the sampling assembly comprises a carousel on which the discrete sample reservoirs are located.

Preferably, at least one of the discrete sample reservoirs comprises a syringe.

Preferably, at least one of the discrete sample reservoirs comprises a bag.

Preferably, the actuator is operable to rotate the carousel in order to allowable multiple sample reservoirs to be presented for connection with an external vessel.

Preferably, the carousel is mounted to the actuator.

Preferably, the actuator comprises a manipulator operable to after the volume of at least one of the discrete sample reservoirs in order to affect the transfer of a substance sample into or out of the sample reservoir.

Preferably, the or each discrete sampling reservoir composes a unique identification code

Preferably, the unique identification code is in machine readable form.

Preferably, the actuator comprises a robotic arm.

As used herein, the term “sampling” is intended to mean the act of sampling or monitoring one or more substances or environments, for example sampling a pharmaceutical substance for quality control purposes or particulate and/or microbial sampling of an enclosed environment to assess particulate and/or microbial levels in said environment.

As used herein, the term “locomotion” is intended to mean movement between locations, and may be achieved by means of a set of wheels, skids, rails, tracks or by any other suitable alternative.

As used herein, the term “vessel” is intended to mean any enclosure within which a flowable substance may be retained whether stationary or in motion, and such a vessel may have a discrete volume or may be continuous, for example a pipe or the like through which a substance may be transported, and furthermore may include the venous or other system of the human or animal body.

### BRIEF DESCRIPTION OF THE DRAWINGS

The present invention will now be described with reference to the accompanying drawings, in which:

FIG. 1 illustrates a perspective view of an autonomous sampling system according to an embodiment of the present invention;

FIG. 2 illustrates a schematic representation of a side elevation of the autonomous sampling system according to the present invention, outfitted with a carousel of sampling syringes:

FIG. 3 illustrates a schematic representation of a side elevation of the autonomous sampling system of the present invention outfitted with a carousel of sampling bags;

FIG. 4 illustrates a schematic representation of a plan view of the carousel provided on the system as illustrated in FIG. 3;

FIG. 5 Illustrates a gripper provided at a free end of a robotic arm of the autonomous sampling system of the invention, holding a sampling bottle beneath a sample point;

FIG. 6 illustrates a wheel disinfecting assembly which may form port of the autonomous sampling system illustrated in FIGS. 1 to 3; and

FIG. 7 illustrates an actuator disinfecting assembly which may form part of the autonomous sampling system illustrated m FIG. 1 to 3.

### DETAILED DESCRIPTION OF THE DRAWINGS

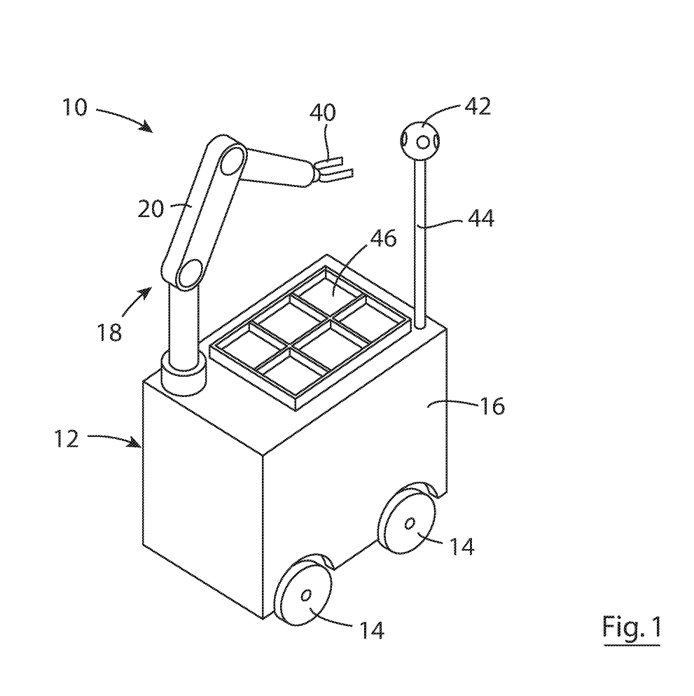

Referring new to FIG. 1 there is illustrated an autonomous sampling system according to an embodiment of the present invention, generally indicated as (10).

The sampling system (10) comprises a base (12) which is capable of autonomous locomotion, and in the embodiment illustrated via two sets of wheels (14) which may be driven by any suitable means, preferably one or more electric motors (not shown) housed within the base (12). It will of course be appreciated that any other suitable alternative means of locomotion may be provided, such as for example one or more tracks or rails, whether ground based of overhead, along which the base (12) may be constrained for movement, or any other suitable alternative. A self contained power supply (not shown) Is preferably provided within the base (12), and in a preferred embodiment is in the form of a rechargeable battery, which may be arranged for wired or wireless charging such that the base (12) may automatically return to a suitable charging station (not shown) when the battery is required to be recharged. The recharging regime may of course be of any other suitable format, for example occurring whenever the system (10) returns to the charging station between operations, regardless of whether the charge level in the battery has fallen below a set threshold.

The sampling system (10) is adapted for the autonomous movement about a facility such as a pharmaceutical manufacturing plant or the like, in order to allow a sample of a substance to be taken from one location, for example a pharmaceutical production line, and to be autonomously transported to an alternative remote location, for example a laboratory at which the sample may be analysed. The sampling system (10) is also designed to conduct environmental sampling or monitoring, such as but not limited to particulate and/or microbial sampling of the air within the facility, as these parameters must be carefully monitored and controlled in order to avoid contamination of the products being manufactured.

The capability for autonomous navigation of the facility may be Implemented in various ways, and for example the sampling system (10) may be provided with a suite of sensors (not shown) which allow the sampling system (10) to safely navigate from location to location. Such sensors may for example include LiDAR, optical image based sensors, tactile sensors and any other necessary sensors depending on the particular operating conditions present at the facility in question. The sampling system (10) will also incorporate a computer control system (not shown) to process and utilise the output from the above sensors in order to correctly control the locomotion of the sampling system. It should however be understood that any other suitable system may be employed in order to facilitate the autonomous locomotion of the sampling system (10) between locations within a given facility. For example the sampling system (10) may be fitted with one or more tracking beacons or markers (not shown), for example infrared LEDs which may be detected by a suitable network of sensors, for example infrared cameras, located about the facility and which can then monitor the location of the sampling system (10) and transmit control information or commands to the sampling system (10) in order to facilitate the autonomous locomotion thereof.

The base (12) comprises a main body (16) within which substantially all of the working components are contained and protected, which body (16) may define one or more storage compartments (not shown) within which equipment such as sampling assemblies (not shown) for conducting the above mentioned sampling and/or monitoring may be stored. Mounted to and extending from an upper face of the body (16) is an actuator (18) comprising a robotic arm (20) which is operable, preferably fully autonomously, to perform the various functions necessary to conduct product and/or environmental sampling or monitoring around the pharmaceutics: facility. The control system (not shown) which uses data received from the suite of sensors to control locomotion of the system (10) is also preferably adapted to control operation of the robotic arm (20), although it is also envisaged that a human operator may be able to control the robotic arm (20) if desired.

The robotic arm 20 may be outfitted with a number of connections depending on the task to be performed, which will vary both by facility and the type of sampling or monitoring being undertaken. In FIG. 1 the robotic arm (20) is provided with a conventional gripper attachment (40) having a pair of jaws which may be opened and closed in order to grip items to be manipulated, and which can also be used to apply pressure, for example to operate switches or the like. The sampling system (10) is also optionally but preferably provided with a video camera (42) which may be of any suitable form, but is preferably adapted to capture 360° video of the environment surrounding the sampling system (10), in order to record all of the events occurring in the vicinity of the system (10) during a monitoring or sampling operation, in order to access whether or not any events occurred about the system (10) which could adversely affect the outcome of the monitoring or sampling. The video captured is preferably recorded and transmitted to a remote location although it is also envisaged that the video feed may be transmitted live in order to allow an operator to observe. In the preferred embodiment illustrated the video camera (42) is mounted on top of an upright (44) such that the video camera (42) is located at approximately head height in order to provide an unobstructed view of the surroundings.

The sampling system (10) may also be provided with a storage tray (48) secured to the upper face of the base (16), and which may be adapted to securely carry, during locomotion of the system (10), one or more environmental and/or product sampling assemblies (not shown). Such sampling assemblies may for example take the form of a vessel such as a bottle, bag or syringe for storing product for subsequent analysis, a petri dish/microbial media for effecting microbial monitoring of the surrounding environment (with or without a unit (not shown) for passing a known volume of air across the surface of the petri dish/microbial growth media) or a particulate sampling assembly (not shown) which may utilise a laser based system in order to count suspended particles in a set volume of the surrounding air.

Thus in use the autonomous sampling system (10) is driven to a particular location within the facility at which environmental monitoring is to be undertaken. The robotic arm (20). using the gripper (40), may then actuate one or more of the sampling assemblies; which may remain in situ on the base (12), for example located in the storage tray (46), or may be placed, again using the robotic arm (20), at a desired location such as a suitable shelf or other surface. The video camera (42) may therefore be utilised to provide a real time image of the surrounding environment in order to assist in the actuation and/or placement of the sampling assembly. The sampling system (10) will then remain in situ for the duration of the test, during which time the video camera (42) will capture the entire surroundings in order to ensure that any potentiality interfering events are captured and considered in analysing the results of the tests. As mentioned above, both the video and the test results may be wirelessly transmitted from the sampling system (10) by suitable on board means, which transmissions are preferably encrypted or otherwise secured for safe transmission. Alternatively once the environmental monitoring tests have been completed the sampling system (10) may transport the sampling assemblies to a laboratory or other location for further analysis.

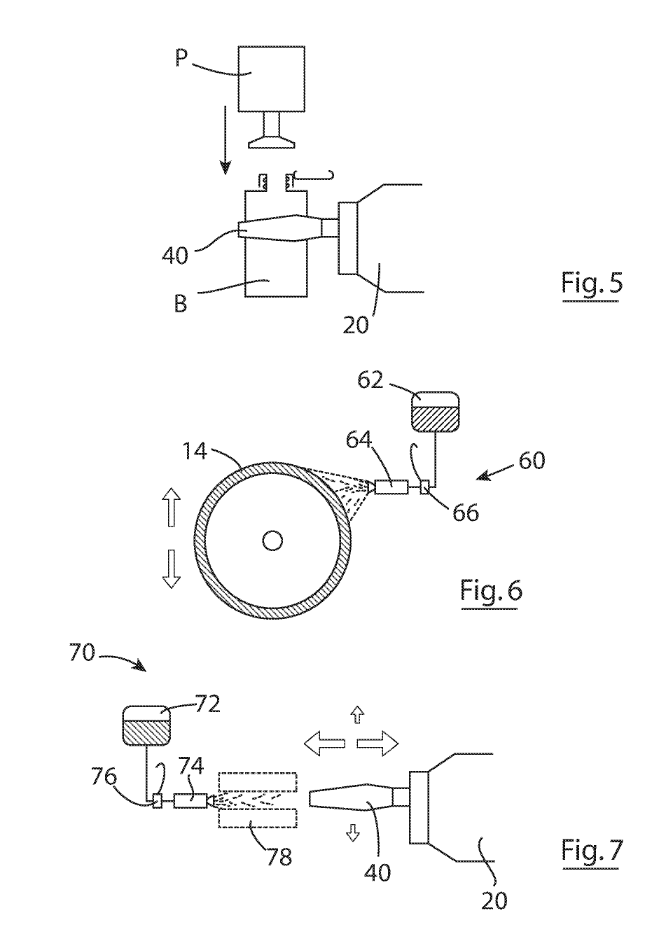

When it is desired to utilise the autonomous sampling system (10) of the invention to undertake product sampling the robotic arm (20) may be adapted to suit the particular sampling operation to be performed, although the gripper (40) may be employed in this operation. For example FIG. 5 shows the robotic arm (20) having the gripper (40) installed thereon and retaining a sample assembly in the form of a sample bottle B which is illustrated being held directly beneath a sample point P which is provided at a suitable location in the pharmaceutical vicinity, for example as part of a production line and from which a sample of the product being manufactured on that line many be dispensed. Thus this sample of product may be dispensed into the bottle B, which may then be suitably sealed in order to protect the integrity of the sample, and the autonomous sampling system (10) may then conduct an on board analysis of the sample or may transport the sample to a remote location at which separate analysis may be performed.

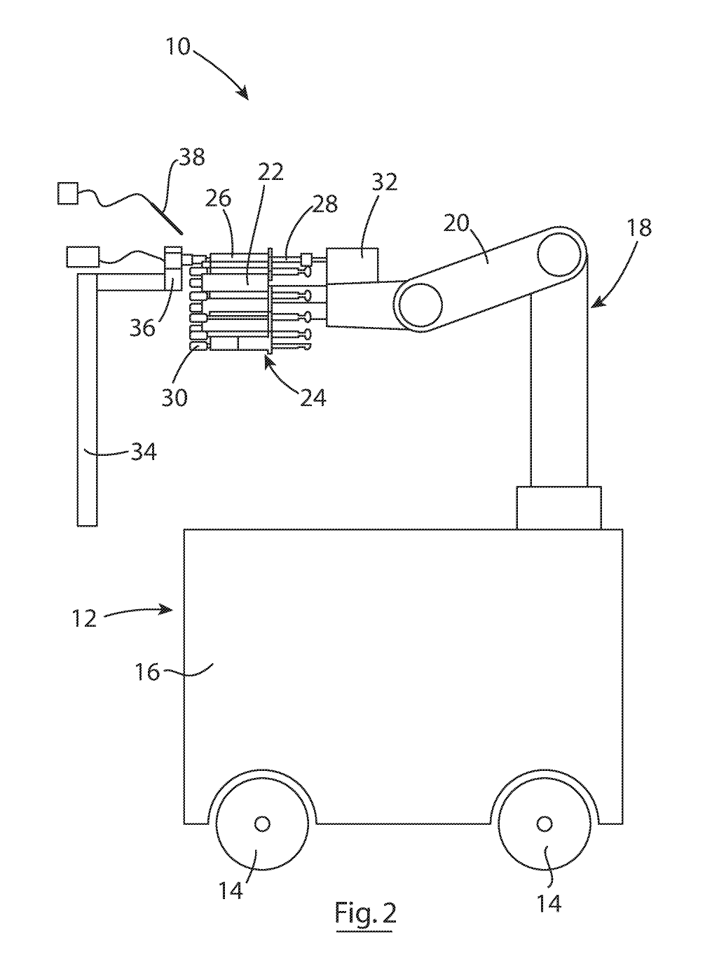

In an alternative arrangement, as illustrated in FIG. 2 the gripper (40) may be replaced with a sampling assembly in the form of a carousel (22) mounted at a free end of the robotic arm (20). Any suitable mechanical and/or electrical and/or hydraulic or pneumatic systems (not shown) may be provided within the body (16) and/or base (12) in order to effect movement of the robotic arm (20). In a particularly preferred arrangement the battery employed to power the wheels (14) may also be used to power the robotic arm (20).

The carousel (22) is adapted to be rotatable on the robotic arm (20) and to releasably retain a plurality of discreet sample reservoirs which, in the embodiment illustrated, are each comprised of a syringe (24) of substantially conventional construction. Thus each syringe (24) comprises a main body (26) of hollow tubular form and in which a substance may be contained, the syringe (24) further comprising a plunger (28) telescopically housed within the main body (26) and which may therefore be depressed relative to the main body (26) in order to reduce or enlarge the working volume of the main body (26) such as to draw a substance into the main body (26) or to eject said substance therefrom. The syringe (24) further comprises a head (30) at an end opposed to that of the plunger (28) and which serves as an access point to the interior volume of the main body (26). It will be appreciated from the following description of the operation of the invention that the syringe (24) could be replaced with any other suitable functional alternative.

The actuator (18) further composes a manipulator (32) which is also mounted to the robotic arm (20) adjacent to the carousel (22), and which is adapted to effect the linear displacement of at least one of the plungers (28) relative to the main body (28) of the respective syringe (24). Again any suitable mechanical electrical, hydraulic or pneumatic mechanisms (not shown) may be employed in order to effect the operation of the manipulator (32).

Thus in use the sampling system (10) will, preferably at pre-determined intervals, autonomously drive to a production line (not shown) or other location from which a sample of a substance is to be taken for analysis. In a preferred embodiment the production line (not shown) may be provided with a dedicated docking station (34) including a port (36) adapted to receive the head (30) of one of the syringes (24). Once at the docking station (34) the sampling system (10) will then operate the robotic arm (20) in order to locate one of the syringes (24) at the correct position and orientation, and will if necessary rotate the carousel (22) in order to bring an empty syringe (24) Into register with the manipulator (32). The robotic arm (20) will then advance the head (30) of the empty syringe (24) into register with the port (36) on the docking station (34). A suitable seal is then established between the port (36) and the head (34), for example through relative rotation and engagement, which may be effected by the port (36) itself.

At this point the manipulator (32) is actuated in order to draw the plunger (28) out of the main body (26) so as to draw a sample of the substance from the production line into the syringe (24). Once a suitable volume of the sample has been taken the above described process may be reversed in order to disengage the bead (30) from the port (36). Before and/or after the port (36) and head (30) are engaged the head (30) may be sprayed with a disinfectant from a dispenser (38) which may be located either on the docking station (34) or integrated with the sampling system (10).

At this point the sampling system (10) will transport itself autonomously to an alternative location, preferably remote from the production line, at which analytical equipment (not shown) is located in order to test the sample contained within the syringe (24). The analytical equipment may be provided with a similar port (not shown) to that of the docking station (34), and again the robotic arm (20) may be employed in order to effect registration between the head (30) of the syringe (24) and said port on the analytical equipment. Once suitably engaged the manipulator (32) may depress the plunger (28) in order to dispense the sample of the substance into the analytical equipment, following which the necessary analysis can be performed.

When the next sample is to be taken from either the same production line or an alternative production line, the above sequence of steps is essentially repeated, although the carousel (22) is first rotated in order to present the next empty syringe (24) into which the next sample may then be taken.

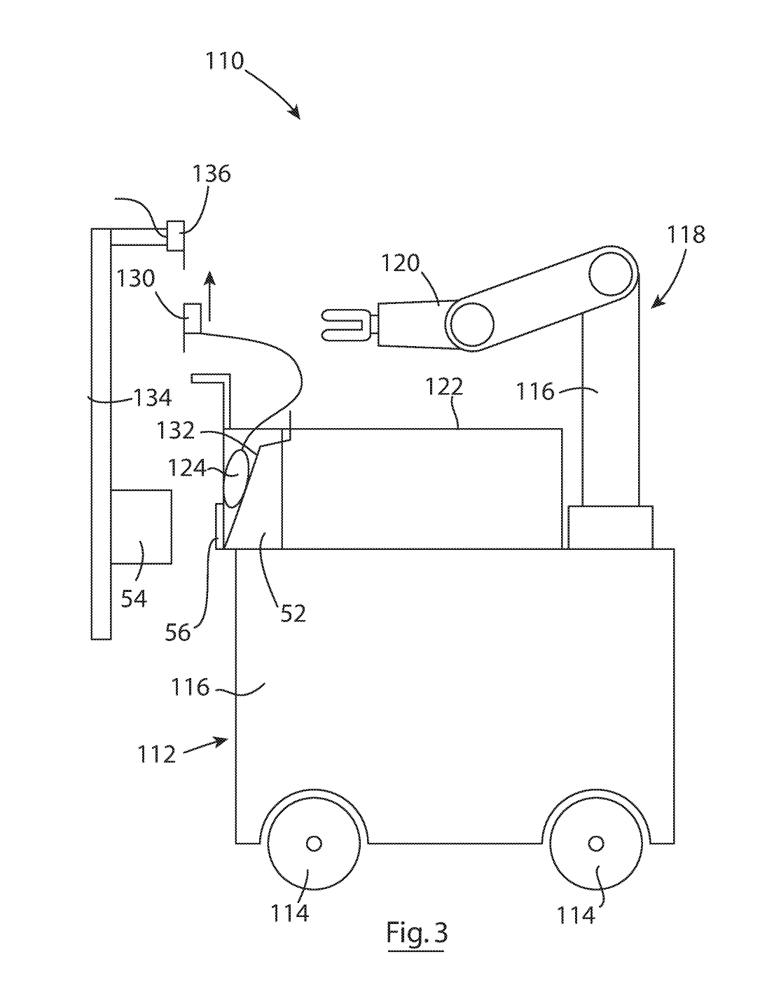

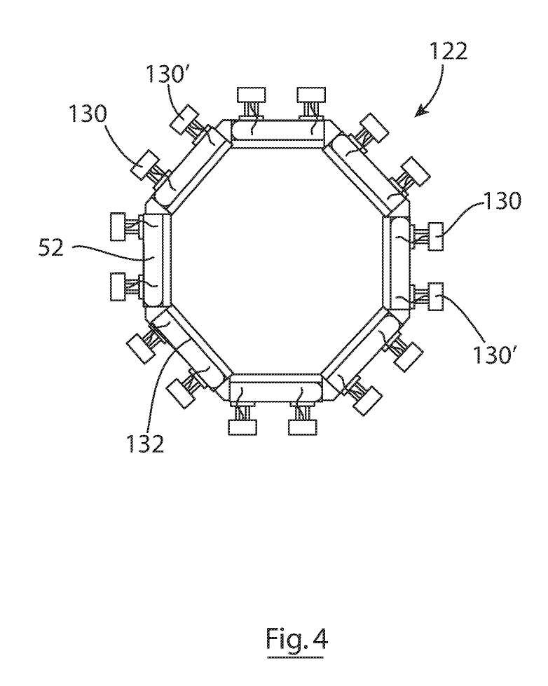

Referring now to FIGS. 3 and 4 there is illustrated an alternative embodiment of a sampling system according to the present invention, generally indicated as (110) In this alternative embodiment like components have been accorded like reference numerable and unless otherwise stated perform a like function.

The sampling system (110) comprises a base (112) adapted for autonomous locomotion, preferably by means of two pairs of wheels (114) located on the base (112). The base (112) further comprises a main body (116) on which is provided an actuator (118) comprising a robotic arm (120) and a sampling assembly in the form of a carousel (122). The carousel (122) is rotatably mounted to the body (116) about a substantially vertical axis and defines a plurality of bays (52). In the embodiment illustrated eight of such bays (52) are provided, each of which is adapted to retain a discreet sampling reservoir in the form of a bag (124). The bags (124) incorporating an inlet connector (130) and associated tubing and an outlet connector (130′) and associated tubing m order to allow a sample of a substance to be transferred into the bag (124) via the inlet connector (130) and out of the bag via the outlet connector (130′). It will of course be understood that any other suitable alternative arrangement may be employed in order to facilitate fluid communication with the bag (124).

The actuator (118) further comprises a manipulator in the form of a hinged pressure plate (132) which may be displaced against the bag (124) in order squeeze live bag (124) against the inner wall of the respective bay (52) such as to force the evacuation of the sample contained within the bag (124) through the outlet connector (130′). Again alternative means may be employed in order to achieve this functionality.

Thus in use the sampling system (110) is autonomously driven to a desired location from which a sample is to be taken, for example a pharmaceutical production line (not shown). The production line or other location may be provided with a docking station (134) via which the sample may be taken. The docking station (134) may be provided with a port (136) which is adapted to be coupled to the inlet connector (130) of the bag (124). Once the sampling system (110) is in position and the carousel (122) has been rotated in order to present an empty bag (124), the robotic arm (120) may then be articulated in order to couple the inlet connector (130) with the port (136) of the docking station (134). Once a suitable connection has been established a sample from the production line (not shown) may then be pumped or otherwise drawn into the bag (124). The robotic arm (120) may then be used to disconnect the inlet connector (130) from the port (136). The docking station may also be provided with a sensor for example an RFID reader (54) or the like, and a corresponding identifier for example in the form of an RFID tag (56) may be provided on each of the bays (52) or the individual bag (124), in order to allow details to be logged for the sample taken, for example the location, time, batch number, etc. of the particular sample. The RFID tag (56) may then be used to effectively track and trace the movement and processing of the sample.

The sampling system (110) is then autonomously transported to a remote location containing analytical equipment (not shown) or the like to which the sample bag (124) may then be connected via the outer connector (130′), preferably utilising the robotic arm (120). The pressure plate (132) may then be displaced against the filled bag (124) in order to force the sample outwardly from the bag (124) via the outlet connector (130′) and into the analytical equipment for the necessary analysis. The robotic arm (120) may then be used to disconnect the bag (124) from the analytical equipment, and the carousel (122) may then be rotated in order to locate the next empty bag (124) in preparation for the taking of the next sample as required.

FIG. 6 illustrates a wheel disinfecting assembly (60) which may be provided about or contained within the base (12) of the sampling system (10), and arranged to disinfect a respective one of the ground contacting wheels (14, 114) of the sampling assembly (10, 110). In the preferred embodiment illustrated the wheel disinfecting assembly (60) comprises a reservoir (62) of disinfectant, which may be positioned at any suitable location within or about the base (12, 112), along with a spray head (64) positioned to issue a jet of the disinfectant onto the ground contacting surface of the wheel (14, 114). The wheel disinfecting assembly (60) additionally preferably comprises an actuator in the form of a solenoid (66) which is remotely actuatable in order to effect the operation of the spray head (64) in order to dispense a dose of the disinfectant onto the wheel (14, 114). It will of course be appreciated that any other suitable functional alternative to the particular components employed may be used to achieve the functionality of the wheel disinfecting assembly (60).

Thus in use as the autonomous sampling system (10, 110) moves about the facility, the wheels (14, 114) may be disinfected as required in order to ensure that sterility is maintained between different areas of the facility as requited. It is envisaged that the autonomous sampling system (10, 110) may be adapted to effect the location based actuation of the wheel disinfecting assembly (60). The sampling system (10, 110) may therefore automatically disinfect the wheels (14, 114) when moving from one location to another within the facility, for example when entering an airlock to pass into a highly sterile environment, and again when returning from said environment.

In Similar fashion, referring to FIG. 7, there is illustrated an actuator disinfecting assembly (70) which is operable to ensure that the robotic arm (20, 120) itself does not cause contamination of samples being taken. The assembly (70) comprises a reservoir (72) for receiving disinfectant, along with a spray head (74) from which the disinfectant may be issued, and a remotely actuatable solenoid (78) operable to effect discharge of the disinfectant from the spray head (74). The disinfecting assembly (70) also preferably comprises a receptacle (78) for receiving a free end of the robotic arm (20) or the gripper (40) directly. In the preferred embodiment illustrated the receptacle (78) comprises a cylindrical foam side wall which may be sprayed with disinfectant prior to the introduction of the gripper (40), and which will serve to retain excess disinfectant. The disinfectant may therefore be sprayed onto the foam side walls of the receptacle (78) and the gripper (40) then introduced into the receptacle (78) in order to disinfect the gripper (40). This task is preferably performed in between each operation carried out by the autonomous sampling system (10). The actuator disinfectant assembly (70) may be provided at any suitable location on the base (12), and may for example be contained internally of the body (18) with a suitable opening in the body (16) providing access to the receptacle (78).

The above disinfecting assemblies (60), (70) therefore ensure that the sampling system (10) can travel about the facility while avoiding the risk of transferring contaminants from one location to another or between samples or sampling assemblies used to carry out the various monitoring operations.

It will therefore be appreciated that the sampling system (10, 110) of the present invention enables samples to be taken from one location and transported to another location for analysts without any human intervention, allowing the continuous operation of high value production facilities such as those found in the pharmaceutical sector, in addition to autonomously conducting environmental monitoring of various sites about the facility and for various environmental contaminants

1. An autonomous sampling system comprising a base adapted for autonomous locomotion about a pharmaceutical facility; a sampling assembly carried on the base and adapted to retain at least one sample of a substance, the sampling assembly comprising a plurality of discrete sample reservoirs and a carousel on which the discrete sample reservoirs are located; and an actuator operable to interact with a the sampling assembly.

2. An autonomous sampling system according to claim 1 comprising one or more ground contacting wheels adapted to facilitate locomotion of the base; and a wheel disinfecting assembly operable to effect disinfection of the one or more ground contacting wheels.

3. An autonomous sampling system according to claim 2 in which the wheel disinfecting assembly comprises at least one nozzle arranged adjacent one or more of the wheels and operable to apply a disinfectant onto the one or more wheels.

4. An autonomous sampling system according to claim 3 in which the wheel disinfecting assembly comprises a disinfectant reservoir in fluid communication with the at least one nozzle.

5. An autonomous sampling system according to claim 4 comprising control means operable to effect the position dependent actuation of the wheel disinfecting assembly.

6. An autonomous sampling system according to claim 1 comprising an actuator disinfecting assembly.

7. An autonomous sampling system according to claim 6 in which the actuator disinfecting assembly comprises a receptacle for receipt of a portion of the actuator; and a dispenser operable to dispense a disinfectant into or about the receptacle.

8. An autonomous sampling system according to claim 7 in which the actuator disinfecting assembly comprises at least one nozzle operable to apply a disinfectant to the portion of the actuator located in the receptacle.

9. An autonomous sampling system according to claim 8 in which the actuator disinfecting assembly comprises a disinfectant reservoir in fluid communication with the at least one nozzle.

10. An autonomous sampling system according to claim 9 comprising control means operable to effect the position dependent actuation of the actuator disinfecting assembly.

11. An autonomous sampling system according to claim 1 comprising a video monitoring system.

12. An autonomous sampling system according to claim 11 in which the video monitoring system comprises one or more video cameras arranged to capture 360° video of the environment surrounding the system.

13. An autonomous sampling system according to claim 1 comprising a transmission system operable to effect the secure transmission of information between the system and a remote location.

14. An autonomous sampling system according to claim 1 comprising a storage compartment for receiving one or more sampling assemblies.

15. An autonomous sampling system according to claim 1 comprising a power supply arranged to supply power for the locomotion of the base and to supply power for operation of the actuator.

16. An autonomous sampling system according to claim 1 comprising a gripper located at a free end of the actuator.

17. canceled

18. canceled

19. canceled

20. canceled

21. An autonomous sampling system according to claim 1 in which at least one of die discrete sample reservoirs comprises a syringe.

22. An autonomous sampling system according to claim 1 in which at least one of die discrete sample reservoirs comprises a bag.

23. An autonomous sampling system according to claim 1 in which the actuator is operable to rotate the carousel in order to allowable multiple sample reservoirs to be presented for connection with an external vessel.

24. An autonomous sampling system according to claim 23 in which the carousel is mounted to the actuator.

25. An autonomous sampling system according to claim 1 in which the actuator comprises a manipulator operable to alter the volume of at least one of the discrete sample reservoirs in order to affect the transfer of a substance sample into or out of the sample reservoir.

26. An autonomous sampling system according to claim 25 in which the or each discrete sampling reservoir comprises a unique identification code.

27. An autonomous sampling system according to claim 26 in winch the unique identification code is in machine readable form.

28. An autonomous sampling system according to claim 1 in which the actuator comprises a robotic arm.
